(19) United States
(12) Patent Application Publication
(10) Pub. No.: US 2009/0041460 A1
(43) Pub. Date: Feb. 12, 2009

(54) Method and apparatus to provide bonded optical network devices

(76) Inventors: Marc R. Bernard, Miramar, FL (US); Joseph C. Roesch, Herndon, VA (US); Douglas A. Atkinson, Ashburn, VA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/891,663

(22) Filed: Aug. 10, 2007

(51) Int. Cl. H04J 14/00

(52) U.S. Cl. 398/67

(57) ABSTRACT

An apparatus and corresponding method for a bonded Optical Network Terminals (ONT) enhances throughput, redundancy and user-port flexibility by Passive Optical Network (PON) services, such as Gigabit-capable (GPON), Broadband PON (BPON), Ethernet PON (EPON) and future PON services, by mechanically or logically externally managing a plurality of individual ONTs as a single bonded ONT while maintaining individual internal management. Further, multiple OLTs may communicate with the same ONT, thereby increasing throughput and providing redundancy. For manufacturers, user-port flexibility reduces time-to-market for unique products to meet specific user needs. That is, different applications may require multiple ONTs to be managed as a single device, yet provide the port counts from various ONTs. For service providers, mechanical or logical combination(s) of ONTs allows management from a user perspective, providing an opportunity for servicing a single device, improving accounting, billing, inventory, etc.

### BACKGROUND OF THE INVENTION

There are traditional networking products that provide limited throughput due to hardware limitations. For example, some Optical Network Terminal (ONT) System on Chip (SoC) products provide one Gigabit Media Independent Interface (GMII) interface, which provides up to 1 Gigabit per second (Gbps) of user capacity to an on-board Ethernet Switch or Network processor that contains several user data ports. There are applications where it is useful for multiple User-to-Network Interface (UNI)-side GMII interfaces to provide greater than 1 Gbps of total user throughput capacity. This requirement applies more to ONTs with several users connected, such as in a business or a multi-dwelling environment. One approach is to create an SoC that provides additional throughput via multiple GMII interfaces. However, that would be expensive to develop and support. Other approaches include multiplexing the individual streams into one stream and then demultiplexing the streams.

Further, customer demands for ONT port combinations that are not currently supported continue to grow. For example, a customer may want a particular port configuration, such as 8 Plain Old Telephone Service (POTS) ports, 2 Ethernet ports, 1 Multimedia over Coax Alliance (MoCA) port, and 1 Radio Frequency (RF) Video port, but the closest available solution only supports a different port configuration, such as 4 POTS, 1 Ethernet, 1 MoCA, and 1 RF Video. Market demand is unclear and variable; therefore the market is unlikely to devote a significant amount of resources to development costs for ONTs. Resources within the ONT organization are better suited to develop other ONTs for higher volume market needs.

Moreover, traditional ONTs only have a single Passive Optical Network (PON) interface. Throughput and redundancy become more important when customers want ONTs that support high user port counts. Therefore, redundancy would provide additional reliability. Although International Telecommunications Union (ITU) Telecommunication Standardization Sector (ITU-T) Recommendations G.983 and G.984 discuss providing redundant interfaces on an Optical Line Terminal (OLT) and/or an ONT, they do not specify how to provide redundancy. Therefore, it would be useful to provide an approach where multiple SoCs, each having a single GMII interface, provide the required bandwidth to the customers.

### SUMMARY OF THE INVENTION

A method and corresponding apparatus for managing user ports of a network element in a communications network applies a global logical grouping, with respect to nodes with respective sets of ports, to the sets of ports normally managed locally within the respective nodes, translates communications from a node hierarchically above the global logical grouping directed to the ports in the global logical grouping to communications directed to the respective sets of ports, and translates communications from the respective sets of ports to the node hierarchically above the global logical grouping to communications from the global logical grouping.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a block diagram of an example network in which example embodiments of the present invention may be employed.

FIG. 2A is a block diagram of two Optical Network Terminals (ONTs) mechanically integrated in an example embodiment bonded ONT.

FIGS. 2B-2D are block diagrams illustrating the storage location of an ONT Abstraction Layer Database at an Element Management System (EMS), Optical Line Terminal (OLT), and ONT, respectively, and communications to and from the bonded ONT.

FIGS. 2E-2F are block diagrams illustrating the abstraction of ports of two ONTs, respectively, of an example bonded ONT according to the ONT Abstraction Layer Database.

FIG. 3A is a block diagram of an example embodiment bonded ONT with n ONTs optically connected by an optical splitter/combiner (OSC).

FIG. 3B is a block diagram of an example embodiment bonded ONT with n ONTs with n respective fiber interfaces, each optically connected to an OSC.

FIGS. 3C-1-3C-2 are block diagrams of an example embodiment bonded ONT with an ONT having m ONT interfaces optically connected to m respective fiber interfaces, the m ONT interfaces passing data through a data aggregation block to and from ports.

FIG. 3D is a block diagram of an example embodiment bonded ONT with n ONT interfaces optically connected to a fiber interface via an OSC, the n ONT interfaces passing data through a data aggregation block to and from ports.

FIG. 4A is a block diagram of the example embodiment bonded ONTs of FIGS. 3A and 3B optically connected to an OSC.

FIG. 4B is a block diagram of the example embodiment bonded ONTs of FIGS. 3C and 3D optically connected to an OSC.

FIGS. 5-1-5-2 are flow diagrams illustrating an example method by which software may be downloaded to the n ONTs of the example embodiment bonded ONTs of FIGS. 3A and 3B.

FIGS. 6A-1-6A-2 are flow diagrams illustrating an example method by which an OLT auto-detects bonded ONTs after the ranging process is complete.

FIGS. 6B-1-6B-2 are flow diagrams illustrating an example method by which multiple OLT interfaces may manage a bonded ONT.

FIG. 7 is a flow diagram illustrating an example method by which a bonded ONT may be provisioned.

FIG. 8 is a flow diagram illustrating an example method by which nodes may be bonded in a network element according to the present invention.

FIG. 9 is a block diagram illustrating an example network element according to the present invention.

FIG. 10 is a flow diagram illustrating an example method by which multiple ONTs may be managed according to the present invention.

### DETAILED DESCRIPTION OF THE INVENTION

A description of example embodiments of the invention follows.

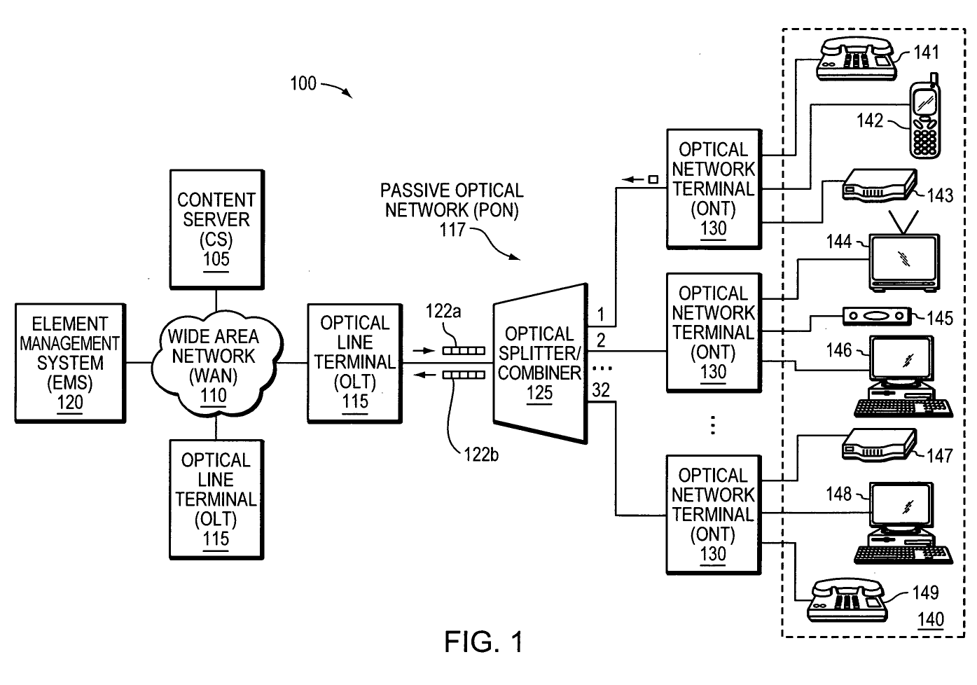

FIG. 1 is a block diagram of an example network 100 in which example embodiments of the present invention may be employed. The network 100 includes a Wide Area Network (WAN) 110 and a Passive Optical Network (PON) 117. The WAN 110 may be a network such as the Internet, and the PON 117 is typically a more localized network in which optical signals, used to transmit information, traverse passive optical elements, such as splitters and combiners, to be communicated between network nodes.

The example network 100 of FIG. 1 includes one or more Optical Line Terminals (OLTs) 115, an Element Management System (EMS) 120, and a Content Server (CS) 105, all connected, generally, by the WAN 110. In the example network 100, each OLT 115 transmits/receives information in the form of a frame of packets 122a, 122b embodied on optical signals to/from an optical splitter/combiner (OSC) 125 to communicate with, for example, thirty-two Optical Network Terminals (ONT) 130. Each ONT 130 receives primary power by local alternating current (AC) power 132 at respective points of installation. The ONTs 130 provide connectivity to customer premises equipment 140 that may include standard telephones 141 (e.g., Public Switched Telephone Network (PSTN) and cellular network equipment), Internet Protocol (IP) telephones 142, network routers 143, video devices (e.g., televisions 144 and digital cable decoders 145), computer terminals 146, digital subscriber line connections, cable modems, wireless access devices, as well as any other conventional, newly developed, or later developed devices that may be supported by the ONT 130.

ONTs 130 may be equipped with batteries or battery backup units (BBUs) 135, interchangeably referred to herein as BBUs 135. In an event an ONT 130 equipped with a BBU 135 experiences an interruption in primary power (e.g., local AC power 132), the ONT 130 may enable the BBU 135 or otherwise accept receipt of power form the BBU 135 to maintain services until the primary power source 132 is restored or the BBU 135 is drained of stored energy.

A bonded ONT includes a plurality of individually integrated or non-integrated ONTs. The bonded ONT is reported and managed as a single ONT with a single ONT identifier and manages ports of each ONT as ports of a single bonded ONT. Among other uses, such as providing particular port configurations at customer installation locations, the combined port management of bonded ONTs increases ease of billing. Depending on the overall system architecture of the PON 117, this solution can impact different elements in the system in terms of the way they communicate with each other. For example, the customer's Operations Support System (OSS) may be capable of configuring a single ONT type.

A method and corresponding apparatus for managing ports of a network element in a communications network, according to an example embodiment of the present invention, applies a global logical grouping, with respect to nodes with respective sets of ports, to the sets of ports normally managed locally within the respective nodes, translates communications from a node hierarchically above the global logical grouping directed to the ports in the global logical grouping to communications directed to the respective sets of ports, and translates communications from the respective sets of ports to the node hierarchically above the global logical grouping to communications from the global logical grouping. The global logical grouping may be applied at an ONT, OLT or EMS of the network.

The method and corresponding apparatus may range multiple communications path interfaces in the network element, one of which may be configured as a management interface. The multiple communication path interfaces provide communications redundancy.

The method and corresponding apparatus may parse the communications to determine to which global logical grouping the communications are directed. The method and corresponding apparatus may report alarms from the respective sets of ports as an alarm from the global logical grouping.

A further method of managing multiple ONTs includes ranging multiple ONTs with respective ports, configuring a controller in a given ONT ranged to communicate with nodes hierarchically above the given ONT on behalf of the multiple ONTs, and distributing to or combining from the ports communications via the controller in the given ONT.

A computer readable storage medium storing instructions for managing ports of a network element in a communications network, wherein upon execution, the instructions instruct a processor to apply a global logical grouping, with respect to nodes with respective sets of ports, to the sets of ports normally managed locally within the respective nodes, translate communications from a node hierarchically above the global logical grouping directed to the ports in the global logical grouping to communications directed to the respective sets of ports, and translate communications from the respective sets of ports to the node hierarchically above the global logical grouping to communications from the global logical grouping.

A Small Office/Home Office (SOHO) may require a particular port configuration, such as 8 Plain Old Telephone Service (POTS) ports, 2 Ethernet ports, 1 Multimedia over Coax Alliance (MoCA) port and 1 Radio Frequency (RF) Video port.

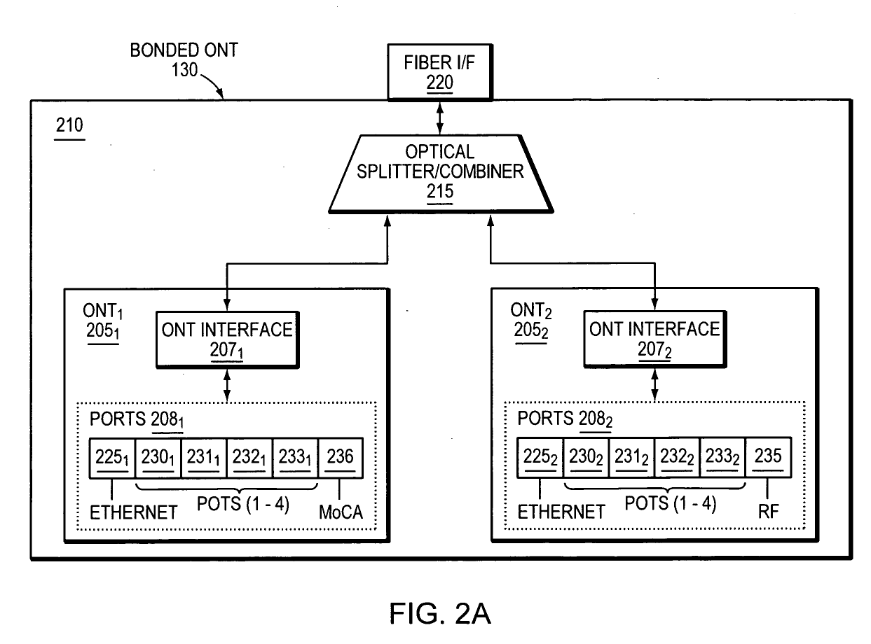

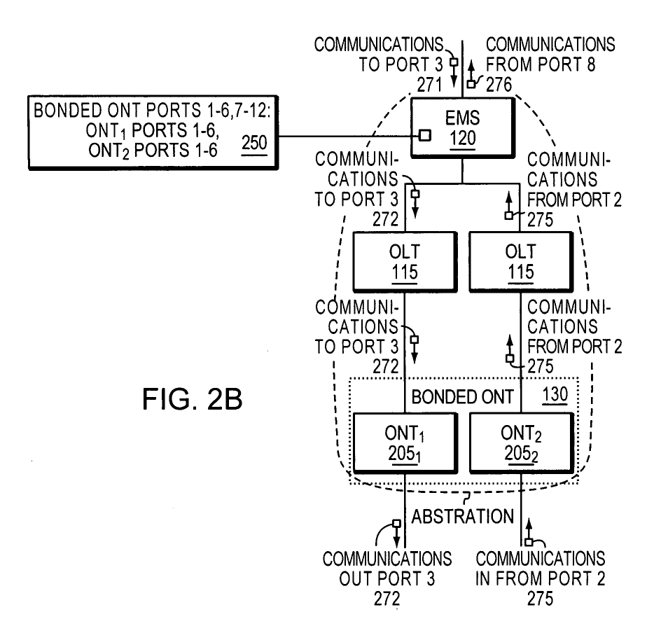

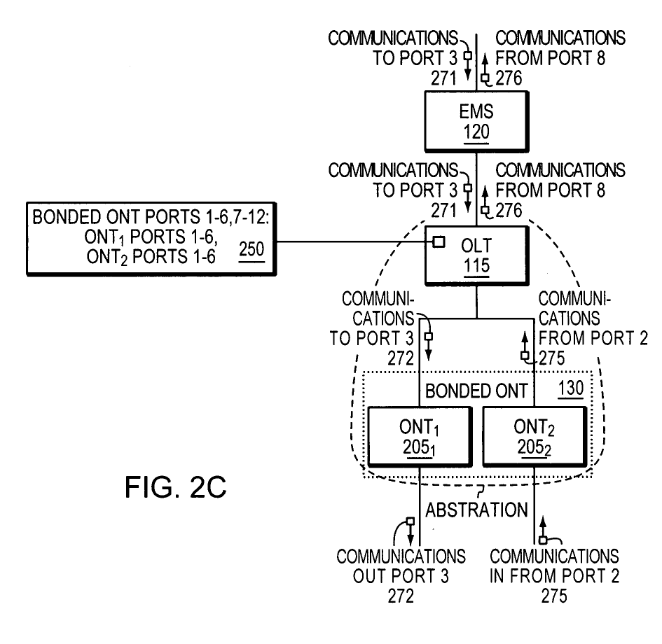

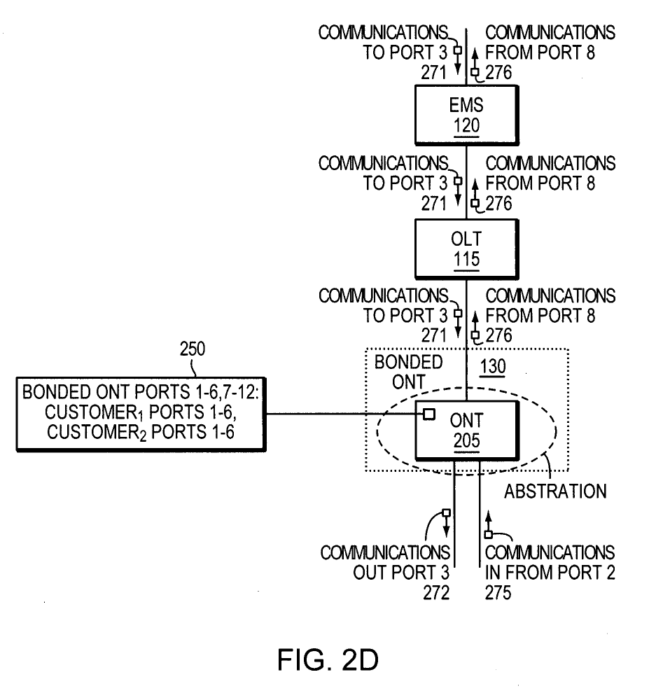

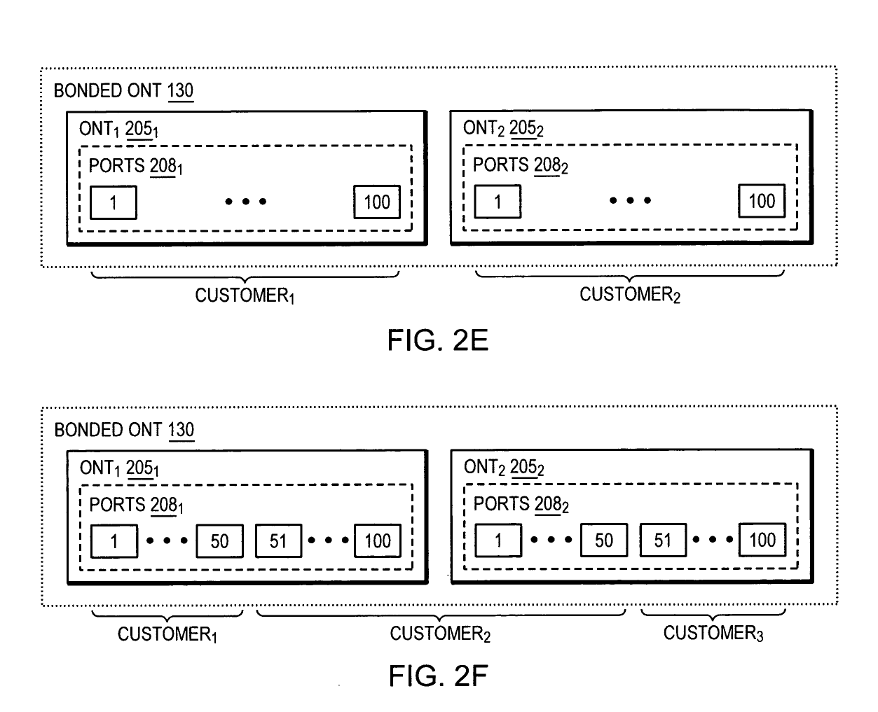

FIG. 2A is a block diagram of an example embodiment bonded ONT 130 with two ONTs 205₁, 205₂ mechanically integrated in one enclosure 210. This bonded ONT 130 meets the above port configuration requirement by providing the port interface example configurations of Table 1.

TABLE 1

| ONT₁ 205₁: | ONT₂ 205₂: |
|---|---|
| 4 POTS ports 230₁-233₁ | 4 POTS ports 230₂-233₂ |
| 1 Ethernet port 225₁ | 1 Ethernet port 225₂ |
| 1 MoCA port 236 | 1 RF Video port 235 |

The global logical grouping of ports of the bonded ONT 130 is mapped to the respective sets of ports of each ONT 205₁, 205₂. In this example embodiment, the two ONTs 205₁, 205₂ are separate logical entities that are managed by an OLT (e.g., OLT 115 of FIG. 1), but are interpreted as a single bonded ONT 130 by the OLT (e.g., OLT 115 of FIG. 1) and an EMS (e.g., EMS 120 of FIG. 1). The bonded ONT 130 is viewable as a single ONT 130 with twelve ports spanning from 1-8 for POTS 230₁-233₁, 230₂-233₂, 1-2 for Ethernet 225₁, 225₂, 1 for MoCA 236, and 1 for RF Video 235.

An abstraction layer for the bonded ONT 130 may be at the ONT 130, OLT 115 or EMS 120 level, where an abstraction layer is defined herein as logic masking the implementation details of applying a global logical grouping, with respect to nodes (e.g., ONTs 130 of FIG. 1) with respective sets of ports, to the sets of ports normally managed locally within the respective nodes (e.g., ONTs 130 of FIG. 1); translating communications from a node (e.g., OLT 115 of FIG. 1) hierarchically above the global logical grouping directed to the ports in the global logical grouping to communications directed to the respective sets of ports; and translating communications from the respective sets of ports to the node (e.g., OLT 115 of FIG. 1) hierarchically above the global logical grouping to communications from the global logical grouping. If abstraction (i.e., global logical grouping) occurs at the ONT 130 level, the bonded ONT 130 reports itself as one ONT 130. If abstraction occurs at the OLT 115 level, the ONTs 205₁, 205₂ report to the OLT 115, which, in turn, reports the ONTs 205₁, 205₂ as a single bonded ONT 130. If abstraction occurs at the EMS 120 level, the ONTs 2051, 2052 and OLT 115 report to the EMS 120, which reports the ONTs 205₁, 205₂ as a single bonded ONT 130.

FIGS. 2B-2D are block diagrams illustrating the storage location of an ONT Abstraction Layer Database 250 at an EMS 120, OLT 115 or ONT 205, respectively, and communications to and from a bonded ONT 130. As illustrated in FIG. 2B, an ONT Abstraction Layer Database 250 may be stored at an EMS 120. Thus, for example, the EMS 120 translates communications 271 to port 3 of a bonded ONT 130 according to the ONT Abstraction Layer Database 250 to communications 272 to port 3 of ONT₁ 205₁. Similarly, for example, the EMS 120 translates communications 275 from port 2 of ONT₂ 205₂ according to the ONT Abstraction Layer Database 250 to communications 276 from port 8 of the bonded ONT 130.

As illustrated in FIG. 2C, an ONT Abstraction Layer Database 250 may be stored at an OLT 115. Thus, for example, the OLT 115 translates communications 271 to port 3 of a bonded ONT 130 according to the ONT Abstraction Layer Database 250 to communications 272 to port 3 of ONT₁ 205₁. Similarly, for example, the OLT 115 translates communications 275 from port 2 of ONT₂ 205₂ according to the ONT Abstraction Layer Database 250 to communications 276 from port 8 of the bonded ONT 130.

As illustrated in FIG. 2D, an ONT Abstraction Layer Database 250 may be stored at an ONT 205. In this example embodiment, the ONT 205 is a bonded ONT 130 serving two customers, Customer₁ and Customer₂ (not shown). Thus, for example, the ONT 205 translates communications 271 to port 3 of the bonded ONT 130 according to the ONT Abstraction Layer Database 250 to communications 272 to port 3 of Customer₁ of the ONT 205. Similarly, for example, the ONT 205 translates communications 275 from port 2 of Customer₂ of the ONT 205 according to the ONT Abstraction Layer Database 250 to communications 276 from port 8 of the bonded ONT 130.

FIGS. 2E-2F further describe the example embodiment of FIG. 2D in which ports of a single ONT (e.g., ONT 205 of FIG. 2D) are abstracted to a plurality of customers, and are block diagrams illustrating the abstraction of ports 208₁, 208₂ of ONT₁ 205₁ and ONT₂ 205₂, respectively, of an example bonded ONT 130 according to the ONT Abstraction Layer Database. As illustrated in FIG. 2E, ports 208₁, 208₂ of a bonded ONT 130 may be configured to serve a plurality of customers, here Customer₁ and Customer₂. In this example embodiment, all ports 208₁ of ONT₁ 205₁, numbered 1 through 100, are abstracted to Customer₁, and all ports 208₂ of ONT₂ 205₂, numbered 1 through 100, are abstracted to Customer₂.

As illustrated in FIG. 2F, ports 208₁, 208₂ of a bonded ONT 130 assigned to a particular customer may be configured to span multiple ONTs, here ONT₁ 205₁ and ONT₂ 205₂. In this example embodiment, a first subset of ports 208₁ of ONT₁ 205₁, numbered 1 through 50, are abstracted to Customer₁, a second subset of ports 208₁ of ONT₁ 205₁, numbered 51 through 100, and a first subset of ports 208₂ of ONT₂ 205₂, numbered 1 through 50, are abstracted to Customer₂, and a second subset of ports 208₂ of ONT₂ 205₂, numbered 51 through 100, are abstracted to Customer₃.

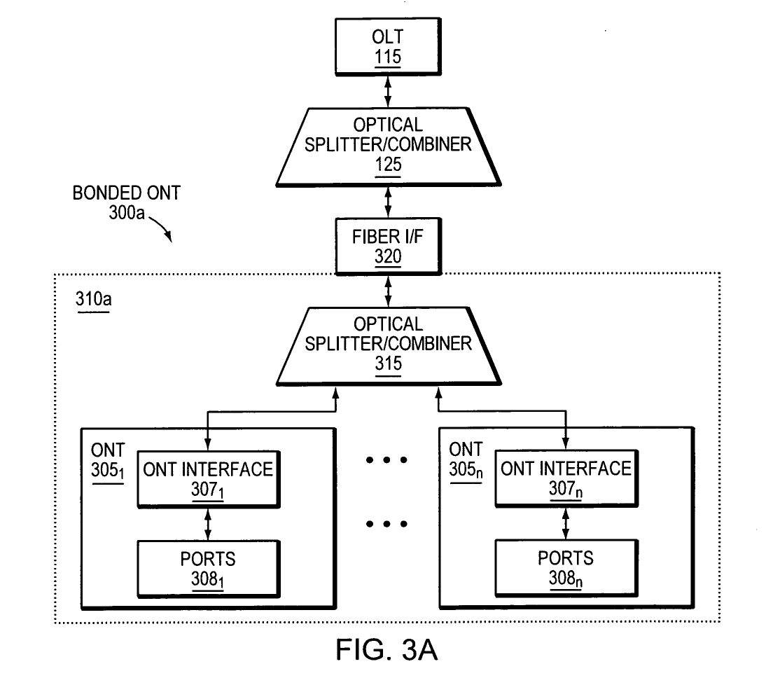

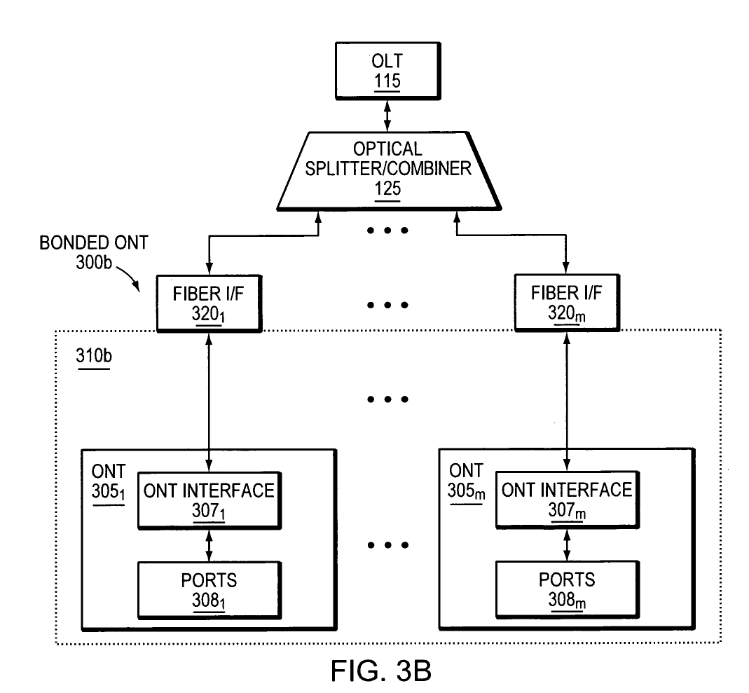

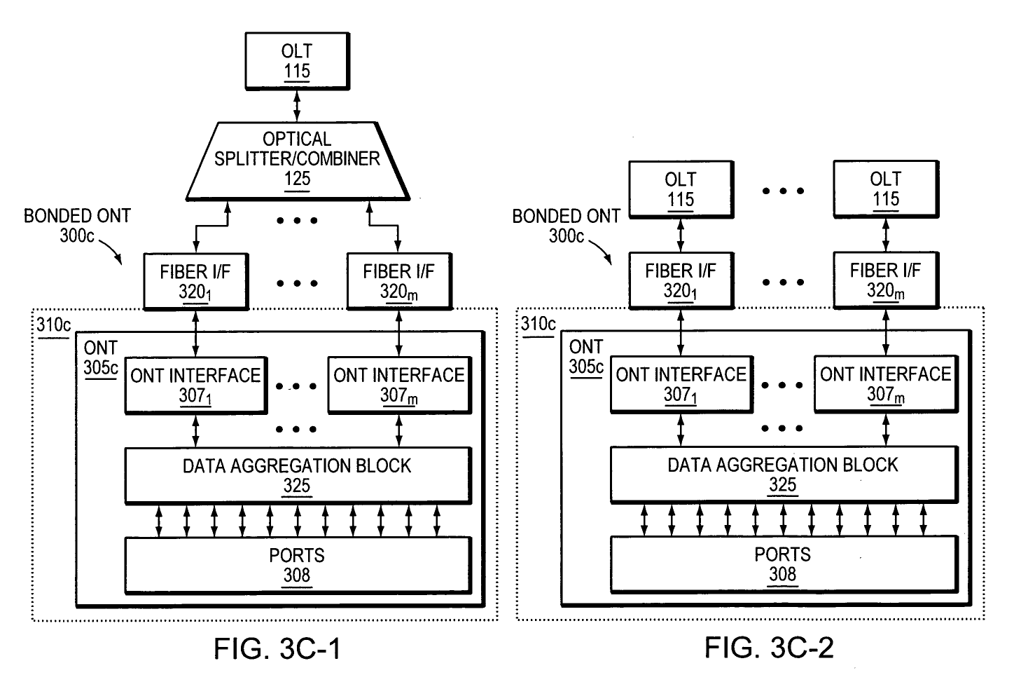

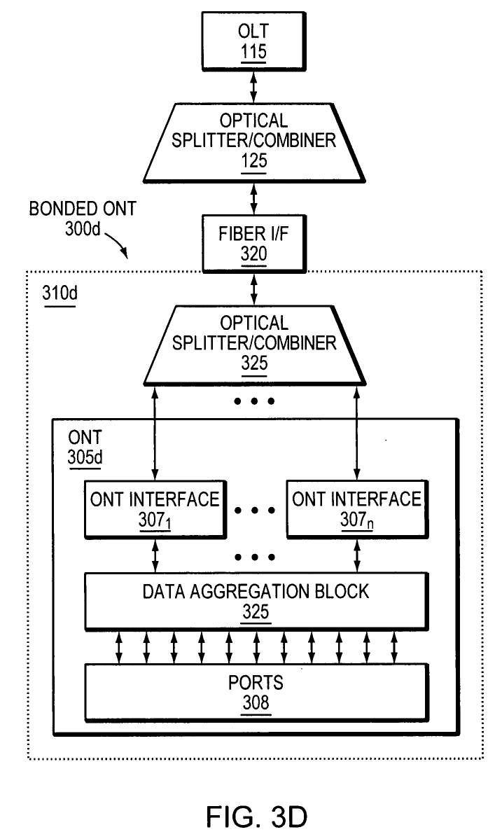

In general, ONTs may be bonded according to at least one of the following example embodiments described in reference to FIGS. 3A-3D.

FIG. 3A is a block diagram of an example embodiment bonded ONT 300a including n ONTs 305₁-305ₙ optically connected by an OSC 315. The ONTs 305₁-305ₙ may be mechanically integrated into a single enclosure 310a, or may be installed as individual ONTs 305₁-305ₙ in the same, or different, installation premises. These ONTs 305₁-305ₙ, whether integrated or non-integrated, are then managed as a single bonded ONT 300a. In this example embodiment, the OSC 315 is integrated within the bonded ONT 300a and optically connected to a single optical fiber terminated at the fiber interface 320 at the installation premises. Optical connections are made between the OSC 315 and the individual ONT interfaces 307₁-307ₙ. The fiber interface 320 optically connects the bonded ONT 300a to an OSC 125 and further to an OLT 115.

FIG. 3B is a block diagram of an example embodiment bonded ONT 300b including n ONTs 305₁-305ₘ with m respective fiber interfaces 320₁-320ₘ, each optically connected to an OSC 125. The ONTs 305₁-305ₘ may be mechanically integrated into a single enclosure 310b, or may be installed as individual ONTs 305₁-305ₘ in the same, or different, installation premises. These ONTs 305₁-305ₘ, whether integrated or non-integrated, are then managed as a single bonded ONT 300b. In this example embodiment, an OSC (e.g., OSC 315 of FIG. 3A) is not integrated within the bonded ONT 300b, which the employs optical fiber connections between the optical fiber interfaces 320₁-320ₘ of the bonded ONT 300b and the nearest OSC 125. Optical connections are made between the respective fiber interfaces 320₁-320ₘ and the ONT interfaces 307₁-307ₘ. The benefit of having multiple fiber interfaces 320₁-320ₘ is that there is less signal loss caused by the OSC (e.g., OSC 315 of FIG. 3A).

FIGS. 3C-1-3C-2 are block diagrams of an example embodiment bonded ONT 300c including an ONT 305c having m ONT interfaces 307₁-307ₘ optically connected to m respective fiber interfaces 320₁-320ₘ, the m ONT interfaces 307₁-307ₘ passing data through a data aggregation block 325 to and from multiple ports 308. The ONT 305c may be mechanically integrated into a single enclosure 310c. In the example embodiment of FIG. 3C-1, each fiber interface 320₁-320ₘ is connected to an OSC 125 to a single OLT 115. Alternatively, as illustrated in FIG. 3C-2, each ONT interface 307₁-307ₘ may communicate with a separate OLT 115. Further, any combination of the embodiments of FIGS. 3C-1 and 3C-2 may be employed in which a subset of fiber interfaces is connected to an OSC to an OLT and other fiber interfaces are individually connected to respective OLTs. Additionally, a similar network may be constructed employing the multiple fiber interfaces 320₁-320ₘ of FIG. 3B or any other bonded ONT with multiple fiber interfaces.

The example embodiments of FIGS. 3C-1 and 3C-2 illustrate a 1:1 configuration of PON fiber interfaces 320₁-320ₘ to ONT interfaces 307₁-307ₘ. However, there may be further example embodiments that provide a 1:M configuration, where a first OLT 115₁-115ₘ can communicate with M1 ONT interfaces 307₁-307ₘ within the integrated ONT 310c, and a second OLT 115₁-115n can communicate with M2 ONT interfaces 307₁-307ₙ on the bonded ONT 300c by way of an OSC (315 of FIG. 3A). In the example embodiment illustrated in FIG. 3C-2, M1 and M2 are equal to one.

The example embodiment of FIGS. 3B, 3C-1 and 3C-2 provide multiple fiber interfaces 320₁-320ₘ and allow for redundancy and additional throughout capacity to the multiple ports 308 of the bonded ONT. In an example embodiment with mixed 1:M1 or 1:M2 configurations, the throughput can be configured to come from predetermined fiber interfaces 320₁-320ₘ. For example, two OLTs may communicate with two independent ONT fiber interfaces (not shown), each supporting a single GMII interface. In such a configuration, the total throughput available to multiple ports 308 is 2 Gbps. However, in another example embodiment, in which two OLTs communicate with a single ONT interface, the ONT interfaces may be capable of supporting a total of 2 Gbps, for a total throughput capacity of 4 Gbps to the multiple ports 308.

FIG. 3D is a block diagram of an example embodiment bonded ONT 300d including n ONT interfaces 307₁-307ₙ optically connected to a fiber interface 320 via an OSC 315, the n ONT interfaces 307₁-307ₙ passing data through a data aggregation block 325 to and from multiple ports 308. The OSC 315 and the ONT 305d are optionally mechanically integrated into a single enclosure 310d.

Various types of bonded ONTs may be employed together in a network.

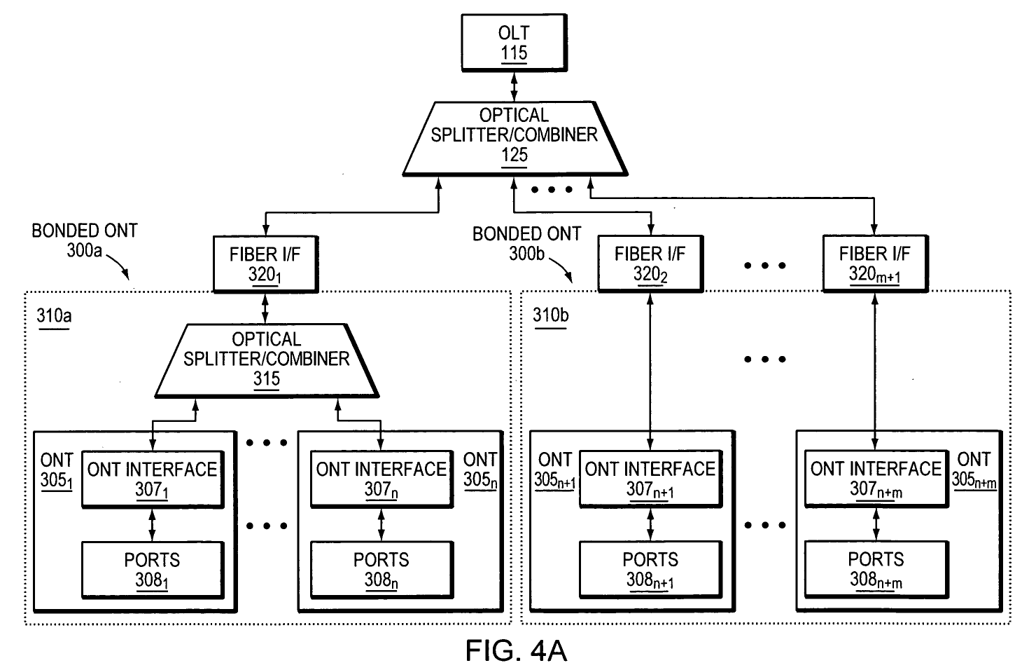

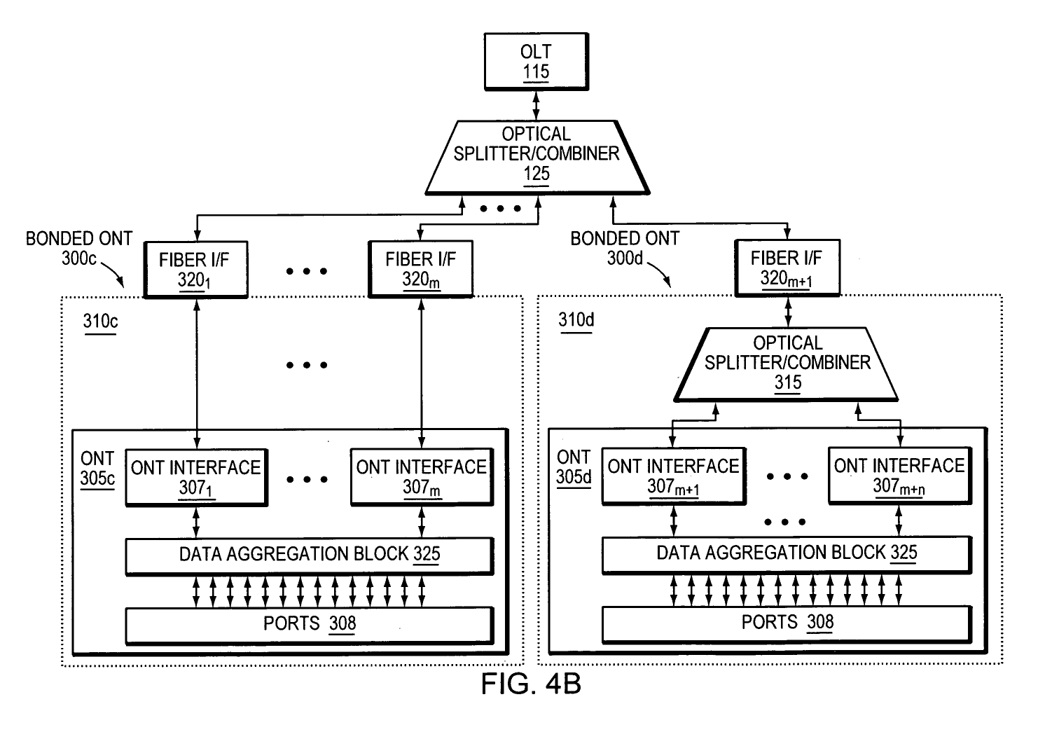

FIG. 4A is a block diagram of the example embodiment bonded ONTs 300a, 300b of FIGS. 3A and 3B optically connected to an OSC 125. In this example embodiment, an OLT 115 is optically connected to the OSC 125, which passes communications to and from the fiber interfaces 320₁, 320₂-320ₘ₊₁ of each bonded ONT 300a, 300b, respectively. Each bonded ONT 300a, 300b of this example embodiment is as described with reference to FIGS. 3A and 3B, respectively, above.

FIG. 4B is a block diagram of the example embodiment bonded ONTs 300c, 300d of FIGS. 3C-1 and 3D optically connected to an OSC 125. In this example embodiment, an OLT 115 is optically connected to the OSC 125, which passes communications to and from the fiber interfaces 320₁-320ₘ, 320ₘ₊₁ of each bonded ONT 300c, 300d, respectively. Each bonded ONT 300c, 300d of this example embodiment is as described above with reference to FIGS. 3C-1 and 3D, respectively.

There are different software management techniques to accommodate different bonded ONT configurations. Example techniques are presented immediately below in reference to FIGS. 5-1 and 5-2.

FIGS. 5-1-5-2 are a flow diagram 500 illustrating an example method by which software may be downloaded to the ONTs 305 of the example embodiment bonded ONTs 300a, 300b of FIGS. 3A and 3B. These example embodiment bonded ONTs 300a, 300b may employ separate software images to be downloaded by the OLT 115 to each ONT 305, respectively. When a service provider requests 505 to update the bonded ONT, the OLT may sequentially download the software images to all ONTs that are part of the bonded ONT.

First, in this example embodiment, the OLT gathers 510 information about software images on all ONTs in the bonded ONT. Then, the OLT begins its iterative cycle 515 by downloading the software image for the n^{th} ONT in the bonded ONT. The OLT then compares 520 the downloaded software image with the presently installed image on the nth ONT to determine if the installed image is up to date. If the image is not up to date 522, the OLT downloads 525 the new image to the nth ONT. After the download, or if the image version is up to date 523, the iterative cycle continues 530 with the next ONT. If there are more ONTs to update 532, the cycle repeats 515. Otherwise 533, if there are no other ONTs, the OLT checks 535 for any failures.

Then, after all updated software images are downloaded, if there are no failures 537, the OLT activates all or subset of software images on the ONTs and reboots the ONTs 555 so they may load the new software image. The ONTs within the bonded ONT are then reranged 560. The OLT then checks if all software images are activated and operational 565. If so 567, the software update ends 570. Otherwise 568, if not all updates software images are activated and operational, or if a failure occurred 538, the OLT generates 540 any applicable failure alarms. These alarms may be general to the bonded ONT or may be specific to the ONT within the bonded ONT that failed the download. The OLT may then reattempt 545 to download the updated software images. If it does 547, the iterative cycle starts 510 again. Otherwise, if the download is not attempted again 548, any additional failure alarms are generated 550 and the software update ends 570. Again, these alarms may be general to the bonded ONT or specific to each ONT within the bonded ONT.

In a network model that contains multiple OLTs, the OLTs may coordinate an ONT Management Communications Interface (OMCI) channel, which may subsequently impact the ONT software download channel. If there are multiple OLTs, then the user (or service provider) either programs a specific OLT to operate the OMCI channel to the ONT or the OLT line cards auto-negotiate this operation. With reference to the example embodiments illustrated in FIGS. 3C-1-3C-2 and 3D, the download can take place on any ONT interface, or over the OMCI channel. Therefore, during the ranging process, the EMS selects an ONT interface on the bonded ONT to set up the OMCI channel. The other ONT interfaces may also support an OMCI channel path in a standby or redundant manner. Either way, in the example embodiments 300a, 300b described with reference to FIGS. 3A and 3B, the ONT is capable of accepting the software download from any interface, although currently the primary OMCI channel may be the easiest way to download it. In this example embodiment, a single software image is suitable because the ONT has two mechanically integrated interfaces.

There are different ways to range a bonded ONT: the OLT is notified of the specific ONT interfaces that are part of a bond group either ahead of time or, alternatively, during a ranging process or by an OLT that collects or receives the information directly from the ONTs that are part of the bond group after the ranging process is complete. In an embodiment in which provisioning of bonded ONT serial numbers is performed ahead of time in the EMS or OLT, the OLT knows which ONTs need to be ranged. If not all ONTs are ranged, the OLT may declare an alarm and may continue providing services.

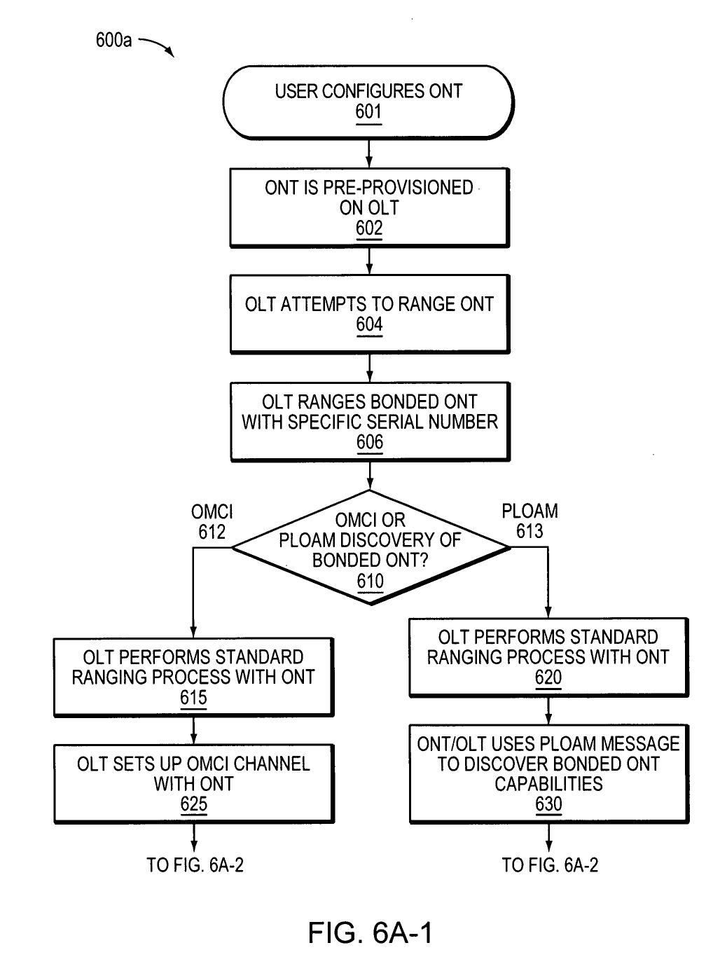

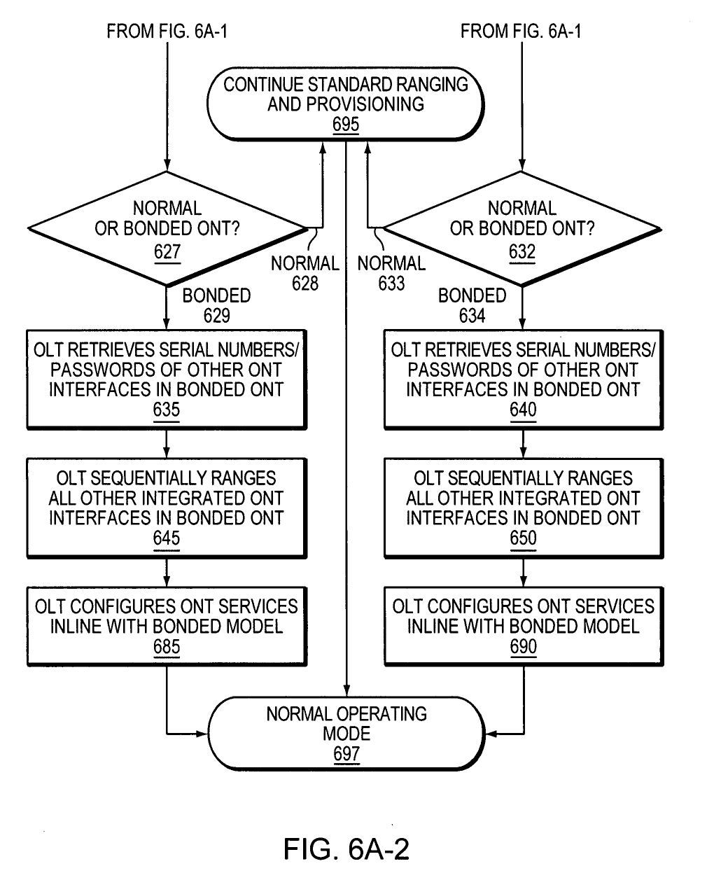

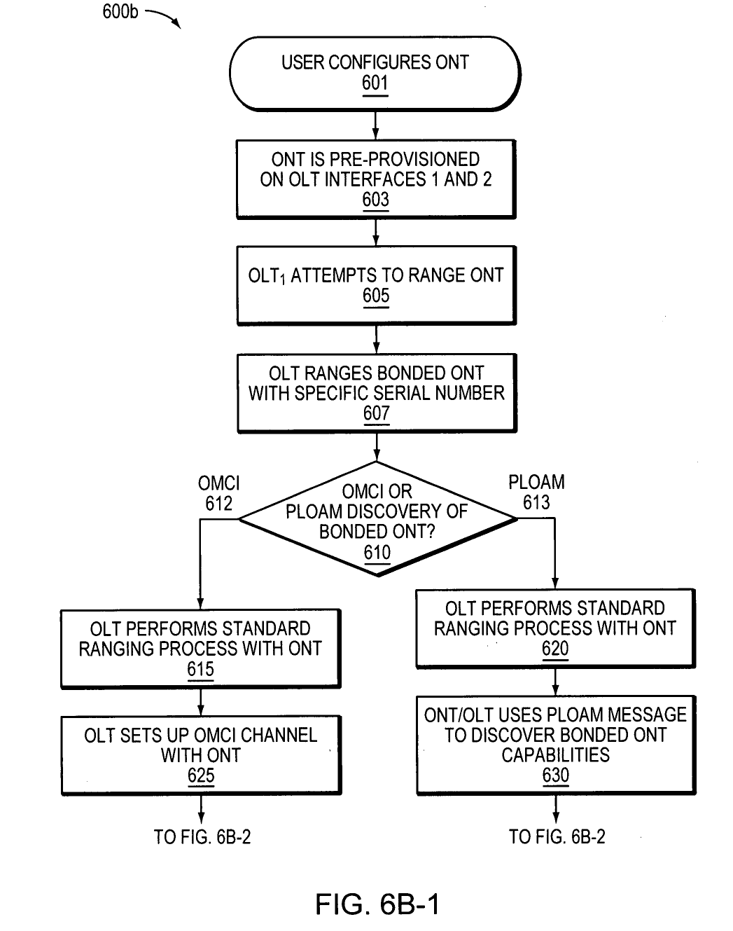

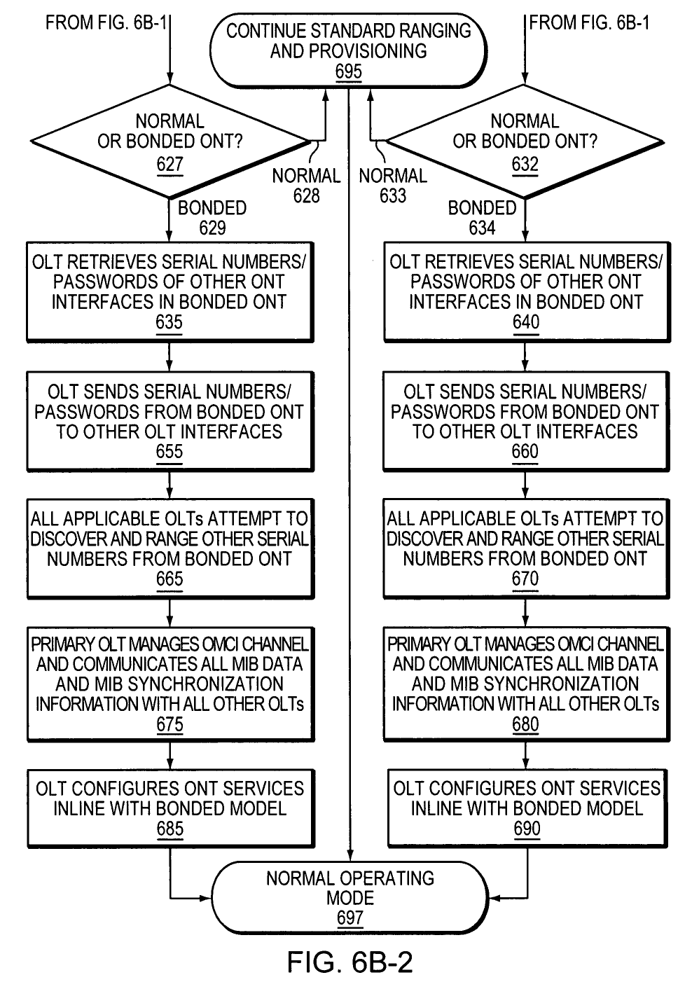

FIGS. 6A-1-6A-2 are a flow diagram 600a illustrating an example embodiment in which an OLT auto-detects bonded ONTs after the ranging process is complete. In ranging the ONT, a user configures 601 the ONT and the OLT pre-provisions 602 the ONT. The OLT them attempts to range 604 the ONT and ranges 606 the ONT with a specific serial number.

The OLT may then use the OMCI channel 612 or a Physical Layer Operations, Administration and Maintenance (PLOAM) message 613 to discover 610 whether the ONT is a bonded ONT. If the OLT uses OMCI 612 to determine whether the ONT is a bonded ONT, the OLT performs the standard ranging process 615 with the ONT. The OLT then sets up the OMCI channel 625 with the ONT and queries 627 whether the ONT is part of a bond group. If the ONT is not a bonded ONT 628, the OLT continues 695 with the standard ranging and provisioning process and the ONT enters normal operating mode 697.

However, if the ONT is a bonded ONT 629, the OLT retrieves 635 the serial numbers and passwords of other ONT interfaces in the bonded ONT. The OLT then sequentially ranges 645 all other integrated ONT interfaces in the bonded ONT. Finally, the OLT configures 685 ONT services in-line with the bonded model and enters normal operating mode 697.

If the OLT uses a PLOAM message 613 to determine whether the ONT is a bonded ONT, the OLT performs the standard ranging process 620 with the ONT. The OLT and ONT then use the PLOAM message to discover 630 the bonded ONT's capabilities and queries 632 whether the ONT is part of a bond group. If the ONT is not a bonded ONT 633, the OLT continues 695 with the standard ranging and provisioning process and the ONT enters normal operating mode 697.

However, if the ONT is a bonded ONT 634, the OLT retrieves 640 the serial numbers and passwords of other ONT interfaces in the bonded ONT. The OLT then sequentially ranges 650 all other integrated ONT interfaces in the bonded ONT. Finally, the OLT configures 690 ONT services in-line with the bonded model and enters normal operating mode 697.

Note that information about the bonded ONT can be provided to the OLT or can be automatically discovered during the ranging or configuration process. Although example embodiments of the present invention address the case where the bonded ONT information can be pre-configured at the OLT, this example embodiment allows for the bond information to be automatically discovered.

The bonded model may already be known to the OLT and may be discoverable during the OMCI/Management Information Base (MIB) discover stage, or at any other time. Discoverability may be useful, particularly if a redundant model is supported, whereby only a single ONT interface is ever active with all others in a standby condition, or in the case in which the ONTs are separate units.

FIGS. 6B-1-6B-2 are a flow diagram 600b illustrating an example embodiment in which multiple OLT interfaces, here two, may manage a bonded ONT. In ranging the ONT, a user configures 601 the ONT. The ONT is then pre-provisioned 603 on OLT interfaces 1 and 2. OLT₁ then attempts 605 to range the ONT, and ranges 607 the ONT with a specific serial number.

The OLT may then use the OMCI channel 612 or a PLOAM message 613 to discover 610 whether the ONT is a bonded ONT. If the OLT uses OMCI 612 to determine whether the ONT is a bonded ONT, the OLT performs the standard ranging process 615 with the ONT. The OLT then sets up the OMCI channel 625 with the ONT and queries 627 whether the ONT is part of a bond group. The OMCI channel is associated with a specific OLT, and the other OLTs may act as standby OMCI paths. With the OMCI channel, a MIB needs to be maintained between the ONT and the OLT. To maintain redundancy between the ONT and OLTs, the OLTs may communicate this MIB information, including MIB-sync parameters, to ensure the OMCI channel can be rapidly activated by any other OLT in the event that the primary OLT is out of service. If the ONT is not a bonded ONT 628, the OLT continues 695 with the standard ranging and provisioning process and the ONT enters normal operating mode 697.

However, if the ONT is a bonded ONT 629, the OLT retrieves 635 the serial numbers and passwords of other ONT interfaces in the bonded ONT. The OLT then sends 655 the serial numbers and password from the bonded ONT to all other OLT interfaces. All applicable OLTs may then attempt to discover and range 665 the other serial numbers from the bonded ONT. The Primary OLT then may manage 675 the OMCI channel and communicate all MIB data and MIB synchronization information with all other OLTs. All OLT interfaces in this example embodiment must communicate OMCI information about the specific bonded ONT. This is useful in case the link between the Primary OLT and the ONT is terminated, so a link can be activated between the ONT and a Secondary OLT. In this case, the ONT may employ a mechanism to switch OMCI commutations to the secondary channel. Finally, the OLT may configure 685 ONT services in-line with the bonded model and enter normal operating mode 697.

If the OLT uses a PLOAM message 613 to determine whether the ONT is a bonded ONT, the OLT performs the standard ranging process 620 with the ONT. The OLT and ONT then use the PLOAM message to discover 630 the bonded ONT's capabilities and queries 632 whether the ONT is part of a bond group. If the ONT is not a bonded ONT 633, the OLT continues 695 with the standard ranging and provisioning process, and the ONT enters normal operating mode 697.

However, if the ONT is a bonded ONT 634, the OLT retrieves 640 the serial numbers and passwords of other ONT interfaces in the bonded ONT. The OLT then sends 660 the serial numbers and password from the bonded ONT to all other OLT interfaces. All applicable OLTs then attempt to discover and range 670 the other serial numbers from the bonded ONT. The Primary OLT may then manage 680 the OMCI channel and communicate all MIB data and MIB synchronization information with all other OLTs. Finally, the OLT configures 690 ONT services in-line with the bonded model and enters normal operating mode 697.

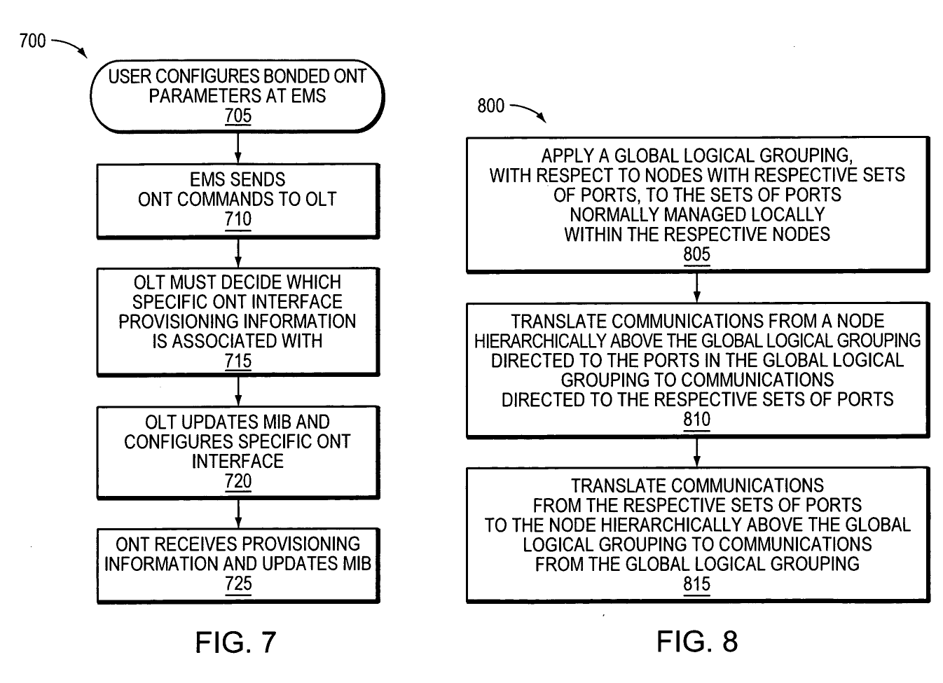

FIG. 7 is a flow diagram 700 illustrating an example method by which a bonded ONT may be provisioned. First, a user configures 705 bonded ONT parameters at the EMS. Note that, in some embodiments, the EMS is only aware of the total ports for the bonded ONT; it is not typically aware of the separate ONTs that are part of the bonded ONT. Other example embodiments of the present invention consider a scenario in which the EMS is aware of the different ONTs included in the bonded ONT.

The EMS then sends 710 ONT commands to the OLT. The OLT decides 715 which specific ONT interface the provisioning information is associated with, updates 720 its MIB, and configures the specific ONT interface. For the example bonded ONTs described with reference to FIGS. 3A and 3B, this information may be sent over a specific OMCI channel to only one of the ONTs. When the information is a generic ONT-wide command (e.g., E-STOP or similar), it is sent over all channels to all ONTs. For the example bonded ONTs described with reference to FIGS. 3C and 3D, this information only goes to a single ONT interface over a single OMCI channel. The integrated ONT is aware of the specific port to which to apply this command. The ONT finally receives 725 the provisioning information and updates its MIB.

FIG. 8 is a flow diagram 800 illustrating an example method of managing ports of a network element in a communications network according to the present invention. First, a global logical grouping, with respect to nodes with respective sets of ports, is applied 805 to the sets of ports normally managed locally within the respective nodes. Next, communications from a node hierarchically above the global logical grouping directed to the ports in the global logical grouping are translated 810 to communications directed to the respective sets of ports. Finally, communications from the respective sets of ports to the node hierarchically above the global logical grouping are translated 815 to communications from the global logical grouping.

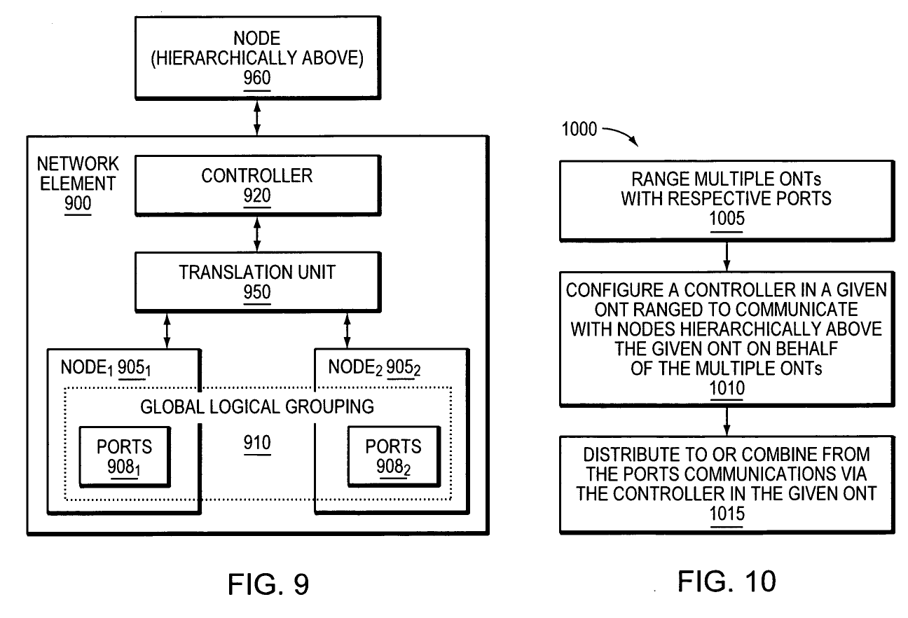

FIG. 9 is a block diagram illustrating an example network element 900 in a communications network according to the present invention. The network element 900 includes ports 908₁, 908₂ normally managed locally within respective nodes 905₁, 905₂, a controller 920 to apply a global logical grouping 910, with respect to nodes 905₁, 905₂ with respective sets of ports 908₁, 908₂, to the sets of ports 908₁, 908₂, and a translation unit 950 to translate communications from a node 960 hierarchically above the global logical grouping 910 directed to the ports 908₁, 908₂ in the global logical grouping 910 to communications directed to the respective sets of ports 908₁, 908₂, and translate communications from the respective sets of ports 908₁, 908₂ to the node 960 hierarchically above the global logical grouping 910 to communications from the global logical grouping 910.

FIG. 10 is a flow diagram 1000 illustrating an example method of managing multiple ONTs according to the present invention. First, multiple ONTs with respective ports are ranged 1005. Next, a controller in a given ONT ranged is configured 1010 to communicate with nodes hierarchically above the given ONT on behalf of the multiple ONTs. Finally, communications are distributed 1015 to or combined 1020 from the ports via the controller in the given ONT.

Provisioning of bonded ONTs may take into consideration that there are separate physical units at the customer premises (e.g., the example embodiments described with reference to FIGS. 3A and 3B in which the ONTs 305₁-305ₙ are not mechanically integrated into the same enclosure 310a, 301b). Alternatively, the EMS may take into consideration whether all ONTs of a bonded ONT are managed as a single device (e.g., a bonded ONT that contains two ONTs, each having four POTS ports and one Ethernet ports, managed as a bonded ONT with POTS ports ranging from one to eight and Ethernet ports ranging from one to two). In this case, the OLT knows the capabilities of the ranged ONTs and maps the ports to the global ports.

The OLT may provide the capabilities to handle alarms from multiple devices and map them to a single ONT-ID alarm that is declared to the EMS. The OLT typically performs the abstraction layer of the bonded ONT. However, the ONT and the OLT may be required to map specific alarms for the PON interface to a generic alarm that is sent upstream in the PON. Therefore, the OLT and/or ONT may support identifying which ONT interface an alarm is declared against.

The OLT may handle performance monitoring from multiple devices and map the valves to a single value that is declared to the EMS. This typically applies to the example embodiments with reference to FIGS. 3A and 3B when the ONTs are not mechanically integrated and are not aware of each other. In the example embodiments with reference to FIGS. 3C-1-3C-2 and 3D, monitoring performance of the ONT can provide values for all fiber interfaces to the OLT, and need not provide any bundling of information unless it is local information that the OLT collect for one of the n fiber interfaces. For example, the OLT may be instructed to report the number of packets transmitted to a specific ONT. The OLT sums the total number of packets on the first interface through the nth interface to report a total to the EMS. Similarly, the ONT may report the total number of packets received across its fiber interfaces. In the example embodiments with reference to FIGS. 3C-1-3C-2 and 3D, the ONT gathers this information for all interfaces, sums it and reports the value. Alternatively, if the EMS is aware of a plurality of fiber interfaces, individual values for each ONT interface may be requested and reported to the EMS.

Similarly, in the example embodiments with reference to FIGS. 3A and 3B, if the EMS requests the total packets that the ONT received on its fiber interfaces, the OLT requests this information from both ONTs, combines the data and reports this value to the OLT. Alternatively, if the EMS is aware of a plurality of fiber interfaces, individual values for each ONT interface may be requested and reported to the EMS.

Further, bonded ONTs may provide redundancy within the PON. Although redundancy is included in International Telecommunication Union (ITU) Telecommunication Standardization Sector (ITU-T) Recommendations G. 983 and G. 984, the standards do not provide guidance for actually providing the redundancy. Redundancy may be provided when the bonded ONT is communicating with a single OLT or multiple OLTs. When the bonded ONT is communicating with a single OLT, the bonded ONT may send all provisioning communications over a single link with, potentially, all data traffic being shared across both ports or uniquely sent over a single PON interface. If the primary PON interface is disconnected, the bonded ONT and the OLT may communicate over one of the other ONT interfaces, with all user traffic or minimally, the most important user traffic, directed over this other link.

Further, the OMCI channel may be maintained. In some example embodiments a secondary OMCI channel may be preconfigured and may be a link that is sufficient to provide redundant voice services and redundant OMCI channels.

Alternatively, it may be used to provide data services to additional ports to increase the overall throughput capacity available to the bonded ONT. For example, if a single ONT interface provides a maximum of 1 Gbps to its ports, then providing a second ONT interface within the bonded ONT increases the overall throughput in the bonded ONT to 2 Gbps. In an extreme scenario, where there are two OLT interfaces and each ONT interface can provide the maximum PON throughput capacity, the bonded ONT may be configured to support up to two times (or more) the maximum PON downstream and two times (or more) the maximum PON upstream capacity. In a Gigabit PON (GPON) scenario, as described in ITU-T G984, with two OLT interfaces and two ONT interfaces, this can be a maximum throughput of 4.976 Gbps (2×2.488 Gbps) downstream and 2.488 Gbps upstream (2×1.244 Gbps).

Example embodiment bonded ONTs may accommodate two separate power supplies (not shown) or two separate BBUs (not shown), or an integrated power supply that houses two independent power supplies and battery backup units (not shown). These may be connected by a composite cable to the bonded ONT or may be connected to separate connections on the individual ONTs. The power solution depends on whether the bonded ONT is mechanically integrated or two separate ONTs logically managed as a single device.

Further, in a bonded ONT, Light Emitting Diodes (LEDs) (not shown) may be associated with the individual physical units. In a more sophisticated solution, the LEDs may be extended to a common area within the device. This would still allow for physical separation of the mechanical units while making troubleshooting and diagnostics simpler. In fact, if these units are housed within a single unit, then the mechanical solution can support a single LED indicating many common conditions indicated by several LEDs, such as power, battery, failures, and network status. The single LED may be connected to both units via an AND gate or similar circuitry, making the internal separation of the two units more transparent. In general, the LED solution is dependent on whether the bonded ONT is mechanically integrated or two separate ONTs logically managed as a single device.

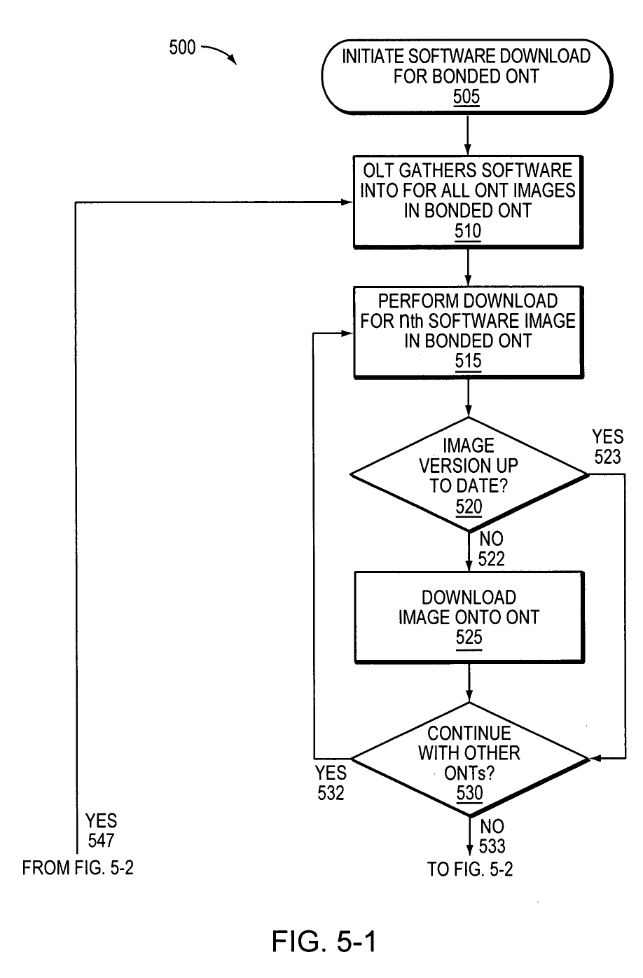

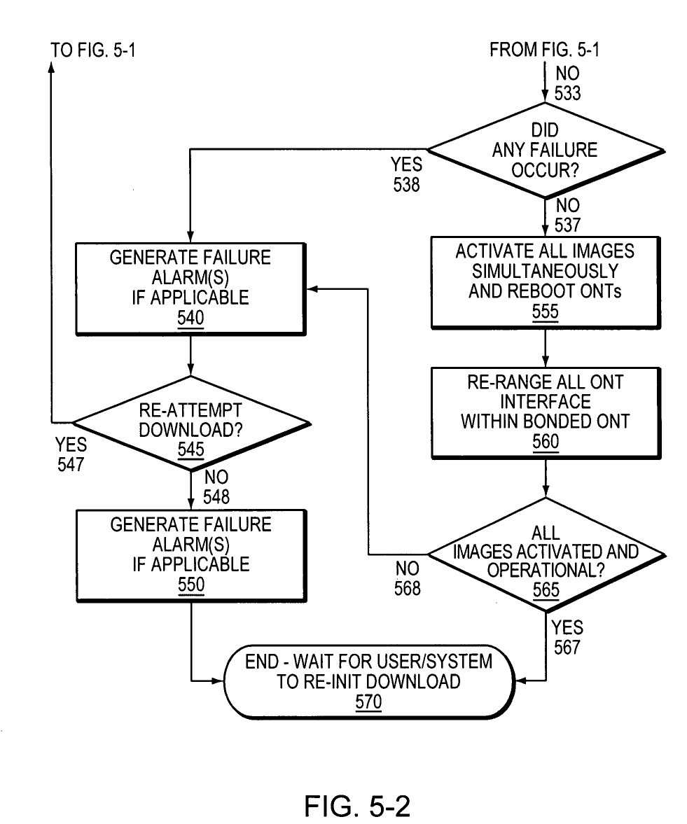

Some or all of the flow diagrams 500 of FIG. 5 or flow diagrams 600a, 600b of FIGS. 6A-1-6B-2 may be implemented in hardware, firmware, or software. If implemented in software, the software may be (i) stored locally with the OLT, the ONT, or some other remote location such as the EMS, or (ii) stored remotely and downloaded to the OLT, the ONT, or the EMS during, for example, start 505. The software may also be updated locally or remotely. To begin operations in a software implementation, the OLT, the ONT, or EMS may load and execute the software in any manner known in the art.

While this invention has been particularly shown and described with references to example embodiments thereof, it will be understood by those skilled in the art that various changes in form and details may be made therein without departing from the scope of the invention encompassed by the appended claims.

It should be apparent to those of ordinary skill in the art that methods involved in the invention may be embodied in a computer program product that includes a computer usable medium. For example, such a computer usable medium may consist of a read-only memory device, such as a CD-ROM disk or convention ROM devices, or a random access memory, such as a hard drive device or a computer diskette, having a computer readable program code stored thereon.

Although described in reference to a PON, the same or other example embodiments of the invention may be employed in an active optical network, data communications network, wireless network (e.g., between handheld communications units and a base transceiver station), or any other type of communications network.

What is claimed is:

1. A method of managing ports of a network element in a communications network, comprising:
applying a global logical grouping, with respect to nodes with respective sets of ports, to the sets of ports normally managed locally within the respective nodes;
translating communications from a node hierarchically above the global logical grouping directed to the ports in the global logical grouping to communications directed to the respective sets of ports; and
translating communications from the respective sets of ports to the node hierarchically above the global logical grouping to communications from the global logical grouping.

2. The method of claim 1 further comprising:
ranging multiple communications path interfaces in the network element.

3. The method of claim 2 wherein the ranging further comprises configuring one communications path interface as a management interface.

4. The method of claim 2 wherein the multiple communications path interfaces provide communications redundancy.

5. The method of claim 1 further parsing the communications to determine to which global logical grouping the communications are directed.

6. The method of claim 1 wherein the global logical grouping is applied at an Optical Network Terminal (ONT) of the network.

7. The method of claim 1 wherein the global logical grouping is applied at an Optical Line Terminal (OLT) of the network.

8. The method of claim 1 wherein the global logical grouping is applied at an Element Management System (EMS) of the network.

9. The method of claim 1 further comprising:
reporting alarms from the respective sets of ports as an alarm from the global logical grouping.

10. A network element in a communications network comprising:
ports normally managed locally within respective nodes;
a controller to apply a global logical grouping, with respect to nodes with respective sets of ports, to the sets of ports; and
a translation unit to translate communications from a node hierarchically above the global logical grouping directed to the ports in the global logical grouping to communications directed to the respective sets of ports, and translate communications from the respective sets of ports to the node hierarchically above the global logical grouping to communications from the global logical grouping.

11. The network element of claim 10 further comprising:
multiple communications path interfaces between the network element and the node hierarchically above the network element.

12. The network element of claim 11 wherein one communications path interface is a management interface.

13. The network node of claim 11 wherein the multiple communications path interfaces are redundant.

14. The network element of claim 10 further including a parser to determine to which global logical groping the communications are directed.

15. The network element of claim 10 wherein the controller is at an Optical Network Terminal (ONT) of the network.

16. The network element of claim 10 wherein the controller is at an Optical Line Terminal (OLT) of the network.

17. The network element of claim 10 wherein the controller is at an Element Management System (EMS) of the network.

18. The network element of claim 10 further comprising:
an alarm unit to report alarms from the ports normally managed locally within respective nodes as an alarm from the network element.

19. A computer readable storage medium storing instructions for managing ports of a network element in a communications network, wherein upon execution, the instructions instruct a processor to:
apply a global logical grouping, with respect to nodes with respective sets of ports, to the sets of ports normally managed locally within the respective nodes;
translate communications from a node hierarchically above the global logical grouping directed to the ports in the global logical grouping to communications directed to the respective sets of ports; and
translate communications from the respective sets of ports to the node hierarchically above the global logical grouping to communications from the global logical grouping.

20. A method of managing multiple Optical network Terminals (ONTs), comprising:
ranging multiple ONTs with respective ports;
configuring a controller in a given ONT ranged to communicate with nodes hierarchically above the given ONT on behalf of the multiple ONTs; and
distributing to or combining from the ports communications via the controller in the given ONT.
